(19) United States
(12) Patent Application Publication
(10) Pub. No.: US 2004/0151826 A1
(43) Pub. Date: Aug. 5, 2004

(54) Injection molded meat-based pet products

(76) Inventor: Robert Stieper Milligan, Lincoin, NE (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/756,373

(22) Filed: Jan. 14, 2004

Related U.S. Application Data
(60) Provisional application No. 60/439,792, filed on Jan. 14, 2003.

(51) Int. Cl. A01J 1/00

(52) U.S. Cl. 426/641; 426/513

(57) ABSTRACT

The present invention provides a real meat-based injection molded chew product that is consistently preferred by dogs, cats, ferrets, and other carnivorous pet animals. The pet chew product is palatable and digestible—as well as long lasting. The product is not brittle and will not shatter or splinter and therefore does not cause choking or injury to the animal's mouth or intestinal tract. Because the product is based upon all natural, real meat that has been made shelf stable, it has a very please meat aroma—even as it is chewed and consumed by the pet. Because the real meat product is an all natural product it does not cause staining to carpets or furniture while it is being chewed and consumed by the pet.

This application claims benefit of priority from U.S. Provisional Patent Application No. 60/439,792, filed Jan. 14, 2003, which is incorporated by reference herein in its entirety.

### SUMMARY OF THE INVENTION

The present invention relates generally to long lasting meat-based pet products, more particularly all natural meat-based injection molded pet products that are long lasting and suitable for dogs, cats, ferrets and other animals that have a strong desire and need to chew or gnaw.

Most dogs, cats, ferrets and other carnivorous animals have strong desires and a need to chew or gnaw and, being carnivores, desire and are attracted to products containing real meat. The product incorporates the use of real meat in combination with copolymers and/or powdered vegetable starches, as a carrying agent, to provide a palatable and flavorful, long lasting chew product for dogs, cats, ferrets and other carnivorous animals. This combination may further comprise nutriceuticals to provide a therapeutic effect. For example, the product may incorporate nutriceuticals like powdered glucosamine to promote the development of healthy joints, facilitate joint repair, and/or prevent joint complications (e.g., hip dysplasia).

The present invention provides a real meat-based injection molded chew product that is consistently preferred by dogs, cats, ferrets and other carnivorous pet animals. The pet chew product is palatable and digestible, as well as long lasting. The product is not brittle and will not shatter or splinter and therefore does not cause choking or injury to the animal's mouth or intestinal tract. Because the product is based upon all natural, real meat that has been made shelf stable, it has a very pleasant meat aroma even as it is chewed and consumed by the pet. Because the real meat product is an all natural product it does not cause staining to carpets or furniture while it is being chewed and consumed by the pet.

### DESCRIPTION OF PREFERRED EMBODIMENTS

The animal products (“meat”) desired by carnivorous animals may include any type of meat product, poultry product, aquatic animal product, or a combination thereof. Meat products and poultry products may include meat from beef, pork, lamb, turkey, chicken, buffalo, venison, rabbit, duck, goose, or a combination thereof. Aquatic animal products may include fish, shellfish, or a combination thereof. The animal products may include various cuts and/or types of meat, such as breast meat, thigh meat, offal items or organ meats (e.g., liver, hearts, gizzards, kidney). Animal products may also include other flesh, bone, and/or organ products. Examples of these flesh, bone, and/or organ products include, but are not limited to, cartilage, cartilage powder, amino acids, and/or bone marrow.

The meat desired by carnivorous animals is made shelf stable using any of a number of known techniques so that the meat incorporated in the final pet chew product is stable even while the product remains at room temperature for extended periods. As part of, or separate from, the technique for making the meat shelf stable, the meat is dried to less than about 20% moisture content by weight, and preferably less than about 10% moisture content by weight, and may be trimmed of excess fat.

The present invention may also comprise nutriceuticals. Examples of nutriceuticals include, but are not limited to, vitamins, amino acids, minerals, enzymes, herbs, and other naturally occurring food supplements or derivatives. Specific examples of vitamins, amino acids, minerals, enzymes, herbs, and other naturally occurring food supplements or derivatives include, but are not limited to, methylsulfonylmethane (MSM), glucosamine, chondroitin, cetyl myristoleate, alfalfa, alpha amylase, beta carotene, blue green algae, brewer's yeast, cat's claw (i.e., Una de Gato), desiccated liver, evening primrose oil, L methionine, oyster shell, papain, pine bark, potassium (citrate), selenium (yeast), shark cartilage, taurine, vitamin C, vitamin E, whey protein, and zinc (dipeptide chelate).

The dried meat (or shelf stable meat) is then pulverized in a stainless steel hammer or pin mill until the desired particle size of between 300 to 1200 microns is achieved. The micron size desired depends on the species and cut of meat being milled. The milled meat product is then screened to remove fines and to assure relative uniformity of size for the milled meat products. Nutriceuticals may be pulverized in the same manner as the dried meat. The properly milled meat product is used at a blend rate or amount of between 10% to 50% (by weight), depending on the species and particular cut of meat.

In one embodiment of the invention, to produce a relatively soft meat-based injection molded chew product, the milled meat product is blended with a polyethylene, high density copolymer (e.g., ALATHON® H 5618) comprising properties within ±20% of the following properties:

| | Nominal | |
|---|---|---|
| | Values (English) | Test Method |
| Physical | | |
| Density | 0.956 g/cm³ | ASTM D1505 |
| Melt Flow Rate | 18.0 g/10 min | ASTM D1238 |
| (190° C./2.16 kg − E) | | |
| Mechanical | | |
| Tensile Strength @ | 4210 psi | ASTM D638 |
| Yield (2 in/min) | | |
| Tensile Strength @ Break | 4000 psi | ASTM D638 |
| Tensile Elongation @ | 7.7% | ASTM D638 |
| Yield (2 in/min) | | |
| Flexural Modulus (0.5 in/min) | | ASTM D790 |
| | 1% Secant: 200000 psi | |
| | 2% Secant: 167000 psi | |
| Hardness | | |
| Durometer Hardness | 69 | ASTM D2240 |
| (D Scale) | | |
| Thermal | | |
| DTUL @66 psi - Unannealed | 167° F. | ASTM D648 |
| Brittle Temperature | −105° F. | ASTM D746 |
| Vicat Softening Point | 257° F. | ASTM D1525 |
| Additional Properties | | |
| Spiral Flow, Equistar | | |
| Test Method: 13 in | | |

In an even more preferred embodiment, the copolymer comprises properties within ±10% of the properties listed above. The milled meat product is blended with the copolymer until homogeneity of the blended product is achieved.

In another embodiment of the invention, to produce a relatively hard meat-based injection molded chew product, the milled meat product is blended with an elastomer and/or copolymer (e.g., DuPont Dow Elastomers ENGAGE® 8411) comprising properties within ±20% of the following properties:

| | Nominal Values | Test Method |
|---|---|---|
| Physical | | |
| Specific Gravity | 0.882 | ASTM D792 |
| Melt Flow Rate | 18 g/10 min | ASTM D1238 |
| Mechanical | | |
| Tensile Strength, Ultimate | 1540 psi | ASTM D638 |
| TnStr @ Ult Pull Rate | 1.97 in/min | |
| Tensile Elongation @ Brk | 1000% | ASTM D638 |
| Elong @ Brk Pull rate | 1.97 in/min | |
| Flexural Modulus | 4200 psi | ASTM D790 |
| FlexMod Modulus Type | Tangent | |
| Hardness | | |
| Durometer Hardness A | 76 | ASTM D2240 |
| Durometer Scale | A Scale | |
| Elastomers | | |
| Tensile Str @ Yield Elast | 370 psi | ASTM D412 |
| Elongation @ Break Elast | 1000% | ASTM D412 |
| Thermal | | |
| Vicat Softening Point | 111° F. | ASTM D1525 |
| Melting Point | 172° F. | |
| Injection | | |
| Processing (Melt) Temp | 350-500° F. | |

In an even more preferred embodiment, the copolymer comprises properties within +10% of the properties listed above. The milled meat product is blended with the copolymer until homogeneity of the blended product is achieved.

In addition to copolymers, other carrying agents which are palatable to animals may also be used. For example, powdered vegetable starches may also be blended with the milled meat product until homogeneity of the blended product is achieved.

A nutriceutical may also be blended with the milled meat product and the carrying agent. When a nutriceutical is blended, the nutriceutical comprises not greater than about 30% by weight of the blended product.

A mold comprising at least one cavity is made and installed into a molding machine or machines. In a preferred embodiment, the mold comprises a finely machined LDPE natural filled (Class 101 Tooled) mold. In a more preferred embodiment, the mold comprises between one and eight cavities.

The blended meat and carrying agent (and/or nutriceutical) mixture is then fed into the mold on the injection molding machines having a barrel or cavity temperature of between 300 degrees to 500 degrees F. In a preferred embodiment, the mixture is subjected to approximately 1,000 psi during the injection molding process.

The residency time in the mold cavity is between 45 to 70 seconds—depending on the species of meat and copolymer being used.

The injection molded chew product is then removed from the mold cavity and allowed to cool to ambient temperature after which it is packed for shipment to pet products retailers.

A preferred embodiment of the present invention provides for an injection molded meat-based composition comprising at least one animal product comprising about 10% to about 50% by weight of the composition and at least one carrying agent comprising about 90% to about 50% by weight of the composition. In this preferred embodiment, the at least one animal product comprises a particle size of between about 300 to about 1,200 microns.

The at least one animal product may comprise a meat product, poultry product, aquatic animal product, or a combination thereof. As such, the at least one animal product may comprise a product from beef, pork, lamb, turkey, chicken, buffalo, venison, rabbit, duck, goose, fish, shellfish, or a combination thereof. The at least one animal product may comprise less than about 20% moisture content by weight. In a more preferred embodiment of the present invention, the at least one animal product comprises less than about 10% moisture content by weight.

In a preferred embodiment of the present invention, the at least one carrying agent comprises a copolymer, powdered vegetable starches, or a combination thereof.

In another preferred embodiment, the composition may further comprise at least one nutriceutical. The nutriceutical may comprise vitamins, amino acids, minerals, enzymes, herbs, or a combination thereof. For example, the nutriceutical may comprise methylsulfonylmethane (MSM), glucosamine, chondroitin, cetyl myristoleate, alfalfa, alpha amylase, beta carotene, blue green algae, brewer's yeast, cat's claw (i.e., Una de Gato), desiccated liver, evening primrose oil, L methionine, oyster shell, papain, pine bark, potassium (citrate), selenium (yeast), shark cartilage, taurine, vitamin C, vitamin E, whey protein, zinc (dipeptide chelate), or a combination thereof.

In a further preferred embodiment, the composition is coated with a treatment. For example, the composition may be coated with a dental treatment (e.g., an amylase-based mixture). In an alternative embodiment, the nutriceutical comprises the treatment and the treatment is homogenized with the blended composition.

While a particular form of the invention has been illustrated and described, it will also be apparent to those skilled in the art that various modifications can be made without departing from the spirit and scope of the invention. Accordingly, it is not intended that the invention be limited except by the appended claims.

What is claimed is:

1. An injection molded meat-based composition comprising:
at least one animal product comprising about 10% to about 50% by weight of the composition;
at least one carrying agent comprising about 90% to about 50% by weight of the composition; and
wherein said at least one animal product comprises a particle size of between about 300 to about 1,200 microns.

2. The composition of claim 1, wherein said at least one animal product comprises a meat product, poultry product, aquatic animal product, or a combination thereof.

3. The composition of claim 2, wherein said at least one animal product comprises a product from beef, pork, lamb, turkey, chicken, buffalo, venison, rabbit, duck, goose, fish, shellfish, or a combination thereof.

4. The composition of claim 1, wherein said at least one animal product comprises cartilage powder.

5. The composition of claim 1, wherein said at least one animal product comprises less than about 20% moisture content by weight.

6. The composition of claim 5, wherein said at least one animal product comprises less than about 10% moisture content by weight.

7. The composition of claim 1, wherein said at least one carrying agent comprises a copolymer, powdered vegetable starches, or a combination thereof.

8. The composition of claim 1, wherein said composition further comprises at least one nutriceutical.

9. The composition of claim 8, wherein said at least one nutriceutical comprises vitamins, amino acids, minerals, enzymes, herbs, or a combination thereof.

10. The composition of claim 8, wherein said at least one nutriceutical comprises methylsulfonylmethane (MSM), glucosamine, chondroitin, cetyl myristoleate, alfalfa, alpha amylase, beta carotene, blue green algae, brewer's yeast, cat's claw (i.e., Una de Gato), desiccated liver, evening primrose oil, L methionine, oyster shell, papain, pine bark, potassium (citrate), selenium (yeast), shark cartilage, taurine, vitamin C, vitamin E, whey protein, zinc (dipeptide chelate), or a combination thereof.

11. The composition of claim 8, wherein said at least one nutriceutical comprises less than or equal to about 30% by weight of the composition.

12. A process for producing an injection molded meat-based product comprising the following steps:
(a) pulverizing an animal product to a particle size of between about 300 and about 1,200 microns, to produce a milled meat product;
(b) blending the milled meat product with a carrying agent until homogeneity of a blended product is achieved; and
wherein the blended product comprises about 10% to about 50% by weight of the milled meat product and about 90% to about 50% by weight of the carrying agent.

13. The process of claim 12, wherein said process further comprises the following steps:
(c) feeding the blended product into a mold; and
(d) removing the blended product from the mold.

14. The process of claim 13, wherein, at step (c), the blended product is fed into the mold at a cavity temperature of between about 300 to 500° F.

15. The process of claim 13, wherein, prior to step (d), the process further comprises a residency time of between about 45 and about 70 seconds.

16. The process of claim 13, wherein said mold comprises at least one cavity.

17. The process of claim 12, wherein step (b) further comprises blending the milled meat product and carrying agent with a nutriceutical.

18. The process of claim 17, wherein said blended product comprises not greater than about 30% by weight of the nutriceutical.

19. The process of claim 13, wherein the mixture is subjected to approximately 1,000 psi during step (c).

20. An injection molded meat-based product obtained by the process of claim 13.
